(19) United States
(12) Patent Application Publication
(10) Pub. No.: US 2018/0043642 A1
(43) Pub. Date: Feb. 15, 2018

(54) MOLD APPARATUS AND METHOD OF USING THE SAME

(71) Applicant: GM Global Technology Operations LLC, Detroit, MI (US)

(72) Inventor: Jason M. Miller, Warren, MI (US)

(21) Appl. No.: 15/234,128

(22) Filed: Aug. 11, 2016

(51) Int. Cl. B29C 70/46; B29C 35/02; B29C 33/10; B29C 70/54

(52) U.S. Cl. CPC B29C 70/467; B29C 70/541; B29C 35/0261; B29C 33/10; B29K 2063/00

(57) ABSTRACT

A number of variations may include a method comprising: providing a mold apparatus comprising at least a first compression mold apparatus member, at least a second compression mold apparatus member, a preform, and a resin, wherein at least one of the first compression mold apparatus member or the second compression mold apparatus member comprises at least one ultrasound emitter; introducing at least one of the preform or the resin into at least one of the first compression mold apparatus member or the second compression mold apparatus member; contacting the first compression mold apparatus member to at least the second compression mold apparatus member to form a closed mold cavity; pressurizing and heating the mold cavity; and curing at least one of the resin or preform using the ultrasound emitter to form a molded component within the mold cavity.

### TECHNICAL FIELD

The field to which the disclosure generally relates to includes mold apparatuses and method of making and using the same.

### BACKGROUND

In a number of variations, a mold apparatus may be used to mold a molded component for use in several applications including, but not limited to, vehicle components.

### SUMMARY OF ILLUSTRATIVE VARIATIONS

A number of variations may include a method comprising: providing a mold apparatus comprising at least a first compression mold apparatus member, at least a second compression mold apparatus member, a preform, and a resin, wherein at least one of the first compression mold apparatus member or the second compression mold apparatus member comprises at least one ultrasound emitter; introducing at least one of the preform or the resin into at least one of the first compression mold apparatus member or the second compression mold apparatus member; contacting the first compression mold apparatus member to at least the second compression mold apparatus member to form a closed mold cavity; pressurizing and heating the mold cavity; and curing at least one of the resin or preform using the ultrasound emitter to form a molded component within the mold cavity.

A number of variations may include a product having a mold apparatus comprising: at least one compression mold apparatus member comprising an exterior surface and an interior surface defining a thickness, and a peripheral edge; and at least one ultrasound emitter operatively attached to the compression mold apparatus member.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a product according to a number of variations.

FIG. 2 illustrates a molded component according to a number of variations.

FIG. 3 illustrates a product according to a number of variations.

FIG. 4 illustrates a method according to a number of variations.

FIG. 5 illustrates a method graph of temperature vs. time of a molded component according to a number of variations.

FIG. 6 illustrates a method graph of temperature vs. time of a molded component according to a number of variations.

### DETAILED DESCRIPTION OF ILLUSTRATIVE VARIATIONS

The following description of the variations is merely illustrative in nature and is in no way intended to limit the scope of the invention, its application, or uses.

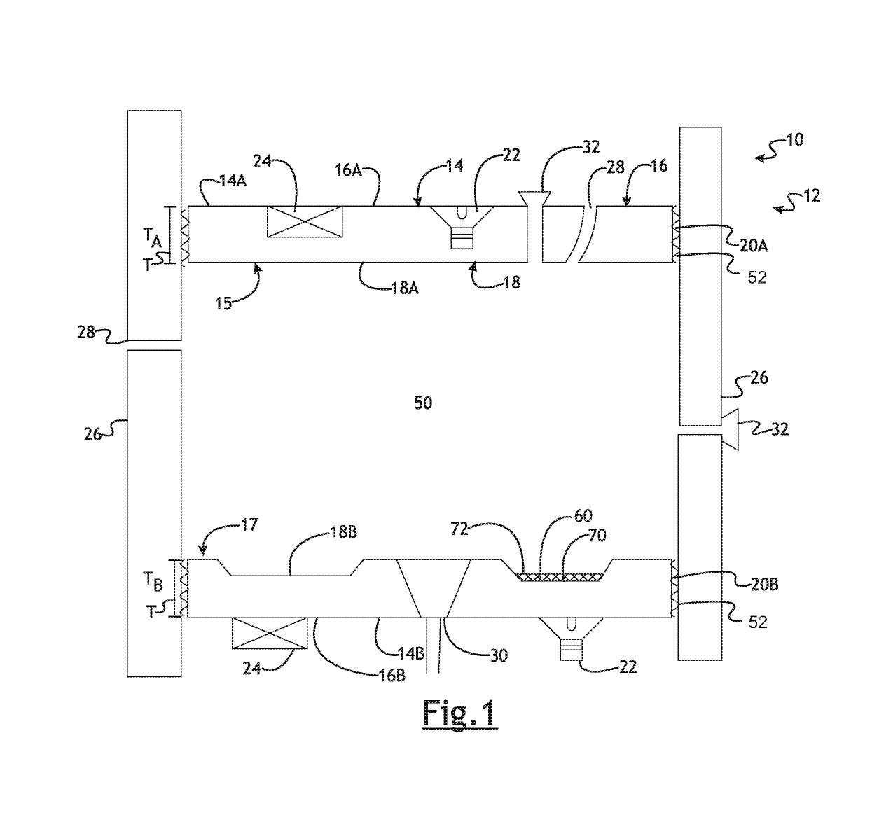

FIG. 1 illustrates a product 10 according to a number of variations. In a number of variations, the product 10 may include a mold apparatus 12. In a number of variations, the mold apparatus 12 may include at least one compression mold apparatus member 14. In a number of variations, the mold apparatus 12 may include a plurality of compression mold apparatus members 14A, 14B. In a number of variations, the mold apparatus member 14 may include an exterior surface 16 and an interior surface 18 defining a thickness T (T_{A}, T_{B}). In a number of variations, the mold apparatus member 14 may include at least one peripheral edge 20 (20A, 20B). In a number of variations, the thickness T may vary along the peripheral edge 20 of the compression mold apparatus member 14. In a number of variations, at least one of the exterior surface 16 or the interior surface 18 may define at least a part of a mold cavity 50. In a number of variations, the compression mold apparatus member 14 may be operatively attached to at least one ultrasound emitter or transducer 22. In a number of variations, the at least one ultrasound emitter 22 is embedded in the thickness of the compression mold apparatus member. In a number of variations, wherein the at least one ultrasound emitter 22 is mounted to at least one of the exterior surface 16 or the interior surface 18 of the compression mold apparatus member 14. In a number of variations, the compression mold apparatus member 14 may include at least one heating component 24. In a number of variations, the heating component 24 may apply heat along at least one of the exterior surface 16 or the interior surface 18 of the compression mold apparatus member 14. In a number of variations, the mold apparatus 12 may further include a support frame 26. In a number of variations, the compression mold apparatus member 14 may be suspended or housed within the support frame 26. In a number of variations, the compression mold apparatus 12 may further include at least one dynamic component 52 that may move the at least one compression mold apparatus member 14 into forming the mold cavity 50 based on the desired application. The dynamic component 52 may be a compression device, a magnetic device, a mechanical device, a pulley device, or may be another type. The dynamic component 52 may include a locking mechanism (not shown). In a number of variations, the compression mold apparatus 12 may include at least one degassing port 28. In a number of variations, the compression mold apparatus 12, or compression mold apparatus member 14 may include at least one ejector pin 30. In a number of variations, the compression mold apparatus 12, or compression mold apparatus member 14 may include at least one part injector 32. In a number of variations, the part injector 32 may introduce the preform 70, resin 60 or prepreg 72 into at least one compression mold apparatus member 14. In a number of variations, the mold apparatus 12 or any of the mold apparatus 12 components (compression mold apparatus member 14, ejector pin 30, part injector 32, support frame 26, degassing port 28, or may be another component) may be made of a plastic material, metal material, composite material, or any material conventionally used for constructing mold devices including any material included in the preform 70.

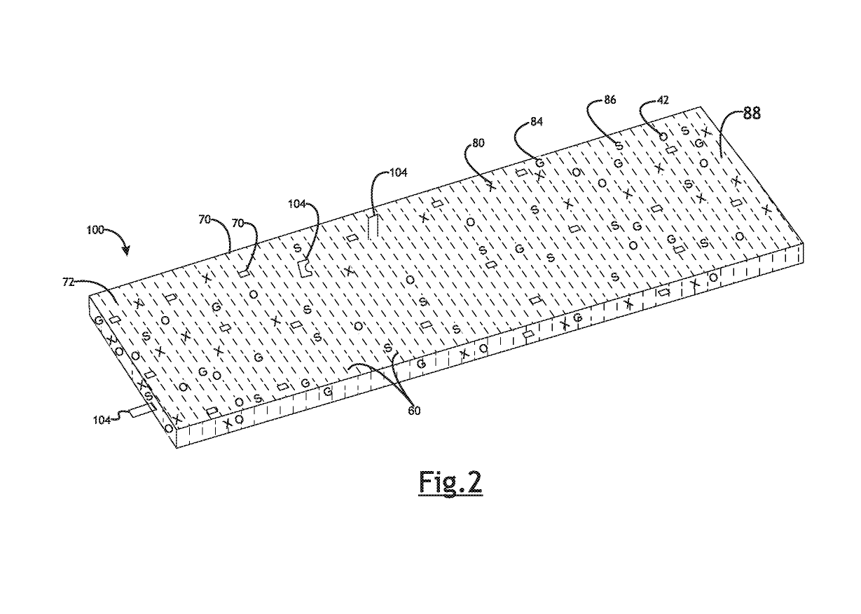

In a number of variations, in reference to FIG. 1, the mold apparatus 12 may be used as a compression mold apparatus. In a number of variations, the mold apparatus may be closed when the at least one compression mold apparatus member 14A meets a different compression mold apparatus member 14B to form a mold cavity 50. In a number of variations, the mold apparatus 12 may be loaded with a resin 60 within at least a portion of the mold cavity 50. In a number of variations, the mold apparatus 12 may be loaded with a preform 70 within at least a portion of the mold cavity 50. In a number of variations, the mold apparatus 12 may be loaded with a prepreg 72 defined herein as a preform 70 that has been impregnated with a resin 60. In a number of variations, at least one of the first compression mold apparatus member 14A, the second mold apparatus member 14B, or mold cavity 50 may be preheated by the heating component 24. In a number of variations, the mold cavity 50 may be any shape depending on the application of a molded component 100 provided by use of the mold apparatus 12. In a number of variations, the mold cavity 50 (and the molded component 100 formed therein in reference to FIG. 2) may be substantially tubular having a cross sectional shape selected from circular shapes, oval shapes (e.g., elliptical shapes), polygonal shapes (e.g., triangular, rectangular—including squares, pentagonal, hexagonal, heptagonal, octagonal, etc.), irregular shapes, and combinations thereof. In a number of variations, the mold cavity 50 (and the molded protrusion formed therein) may be elongated, for example in the form of an elongated slot or channel. In a number of variations, operation of the mold apparatus 12 may result in the formation of a molded component 100 formed from at least one of the resin 60, preform 70, or prepreg 72.

In a number of variations, in reference to FIGS. 1-2, the preform 70 may include a fiber. In a number of variations, the preform 70 may include a fabric. In a number of variations, the preform 70 may be woven. In a number of variations, the preform may be a plurality of fibers. In a number of variations, the fibers may be textile, natural or synthetic or may be another type. In a number of variations, the fibers in the preform 70 may include animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, silica, modal rayon, rayon, glass, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon fiber, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, and S-glass, or may be another type), basalt, aluminum, nano-fibers, composites or combinations thereof, or may be another type. In a number of variations, the preform 70 may contain combinations of the above in varying concentrations and the components may be intermixed. In a number of variations, the substrate 14 may be formed by sheets, continuous mats, or as continuous filaments. In a number of variations, the preform 70 may be formed using a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. In a number of variations, the preform 70 may be manufactured in a two dimensional or three dimensional orientation. In a number of variations, the preform 70 may include short-fiber reinforced materials or continuous fiber-reinforced materials or may include another type. In a number of variations, the preform 70 may be manufactured or woven through weaving, knitting, braiding, stitching, plain weaving, satin weaving, or may be manufactured in another way. In a number of variations, the preform 70 may include a metal material including, but not limited to, plastic steel, stainless steel, copper, nickel, tin, noble metals, zinc, iron, bronze, aluminum, silicon, titanium, or platinum composites or combinations thereof, or may be another type. In a number of variations, the preform 70 may comprise a polymer or plastic material including, but not limited to, natural rubber, synthetic rubber, silicone rubber, fluoroelastomer rubber, butyl rubber (isobutylene-isoprene), hypalon rubber (chlorosulphonated polyethylene), epichlorohydrin rubber (epichlorohydrin), ethylene propylene diene rubber, fluorocarbon rubber, fluorosilicone rubber, hydrogenated nitrile rubber, nitrile rubber, perfluoroelastomer rubber, polyacrylic rubber, chloroprene rubber, polyurethane rubber, styrene butadiene rubber, acrylonitrile-butadiene rubber, hydrogenated acrylonitrile-butadiene rubber, ethylene acrylic rubber, phenol formaldehyde, polyether urethane, polyester urethane, neoprene, nylon, polyvinyl chloride, polystyrene, polyethylene, polypropylene, polyurethane, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, Acrylonitrile butadiene styrene (ABS), Acrylic (PMMA), Celluloid, Cellulose acetate, Cycloolef in Copolymer (COC), Ethylene-Vinyl Acetate (EVA), Ethylene vinyl alcohol (EVOH), Fluoroplastics (including PTFE, FEP, PFA, CTFE, ECTFE, ETFE) Ionomers, Kydex™, a trademarked acrylic/PVC alloy, Liquid Crystal Polymer (LCP), Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polycaprolactone (PCL), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, Polyetheretherketone (PEEK), Polyetherketoneketone (PEKK), Polyetherimide (PEI), Polyethersulfone (PES), Polysulfone, Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polystyrene (PS), Polysulfone (PSU), Polytrimethylene terephthalate (PTT), Polyurethane (PU), Polyvinyl acetate (PVA), Polyvinyl chloride (PVC), Polyvinylidene chloride (PVDC), Styrene-acrylonitrile (SAN), polycarbonate+ acrylonitrile butadiene styrene mix (ABS+PC), Polypropylene (PP) (including, but not limited to, impact, random, and homo), Polyethylene (PE) (including, but not limited to, linear low density, linear high density), combinations or blends in any amount thereof, or may be another type. In a number of variations, the preform 70 may include a homopolymer, copolymer, terpolymer, or may be another type. In a number of variations, the preform 70 may be a combination of polymers in any amount or concentration. In a number of variations, the preform 70 may have components of fabric, fiber, metal, or polymer mixed together in any concentration. In a number of variations, the preform 70 may have various widths, lengths and/or diameters of fibers as well as in its overall dimensions. In a number of variations, the preform 70 may be preimpregnated, coated, or otherwise in contact with the resin 60 to form a prepreg 72.

In a number of variations, in reference to FIGS. 1-2, the resin 60 contacting the preform 70 may result in adherence or bonding between the resin 60, the preform 70, the prepreg 72, or any combination thereof. In a number of variations, the resin 60 may include urethane resin, vinylester resin, polyester resin, epoxy resin, phenolic resin, modified phenolic resin, or may be another type. In a number of variations, the resin 60 may be reactive or non-reactive. In a number of variations, the resin 60 may be applied to or deposited on the preform 70 through dip coating, spray coating, flow coating, painting, or may be applied or deposited a different way. In a number of variations, the preform 70 may be preimpregnated, coated, or otherwise in contact with the resin 60 to form a prepreg 72.

In a number of variations, in reference to FIGS. 1-2, the preform 70 or prepreg 72 may include a filler 76. In a number of variations, the filler 76 may be calcium carbonate, carbon fibers, talc, mica, woliastonite, calcinated clay, kaolin, magnesium sulfate, magnesium silicate, barium sulphate, titanium dioxide, sodium aluminum carbonate, barium ferrite, and potassium titanate, graphite, diatomaceous earth, silica, glass, carbon, carbide particles, ceramic particles, rubber, nitride, nitrile, phenolic, zeolite, aramid, montmorillinite clays, magnesium oxide whiskers, combinations thereof, or may be another type. In a number of variations, the filler 76 may take the form of particles. In a number of variations, the filler 76 particles may range in diameter from about 1 to about 150 μm. In a number of variations, the filler 76 particles may range in diameter from about 50 to about 500 μm. In a number of variations, the filler 76 particles may be spherical, oblong, cubical, polyhedral, elliptic, oval, cocoon, whisker, rectangular, irregularly shaped, combinations thereof, or may be another type. In a number of variations, the filler 76 particles may be uniformly distributed or aggregated throughout the preform 70 or prepreg 72. In a number of variations, the filler 76 may comprise at least about 0 to about 30% of the preform 70 or prepreg 72 by weight.

In a number of variations, in reference to FIGS. 1-2, the preform 70 or prepreg 72 may further comprise one or more heat stabilizers 80. The one or more heat stabilizers 80 may include copper salts and/or derivatives thereof. In a number of variations, the heat stabilizers 80 may include copper halides or copper acetates; divalent manganese salts and/or derivatives thereof and mixtures thereof. In a number of variations, copper salts may be used in combination with halide compounds and/or phosphorus compounds, and may be used in combination with iodide or bromide compounds, and may be used in combination with potassium iodide or potassium bromide. In a number of variations, when present, the one or more heat stabilizers 80 may be present in an amount from at or about 0.1 to at or about 3 wt-%, or from at or about 0.1 to at or about 1 wt-%, or from at or about 0.1 to at or about 0.7 wt-%, the weight percentage being based on the weight of the preform 70 or prepreg 72.

In a number of variations, in reference to FIGS. 1-2, the resin 60 may further comprise one or more antioxidants 42 such as phosphate or phosphonite stabilizers, hindered phenol stabilizers, hindered amine stabilizers, aromatic amine stabilizers, thioesters, and phenolic based antioxidants. In a number of variations, when present, the one or more antioxidants 42 may comprise from at or about 0.1 to at or about 3 wt-%, or may comprise from at or about 0.1 to at or about 1 wt-%, or may comprise from at or about 0.1 to at or about 0.7 wt-%, the weight percentage being based on the weight of the resin 60 composition.

In a number of variations, in reference to FIGS. 1-2, the preform 70 or prepreg 72 may further comprise one or more impact modifiers 84. In a number of variations, the impact modifiers 84 may include polyamide ionomers, carboxyl-functionalized polyolefins, plastomers, co-polymer TPEs, TPVEs, natural rubbers and/or mixtures or combinations thereof.

In a number of variations, in reference to FIGS. 1-2, the preform 70 or prepreg 72 may further comprise ultraviolet light stabilizers 86 such as, but not limited to, hindered amine light stabilizers (HALS), carbon black, substituted resorcinols, salicylates, benzotriazoles, and benzophenones. In a number of variations, the preform 70 or prepreg 72 may further comprise general modifiers 88 such as, but not limited to, flow enhancing additives, lubricants, antistatic agents, coloring agents, pigments, flame retardants, nucleating agents, crystallization promoting agents and other processing aids known in the polymer compounding art.

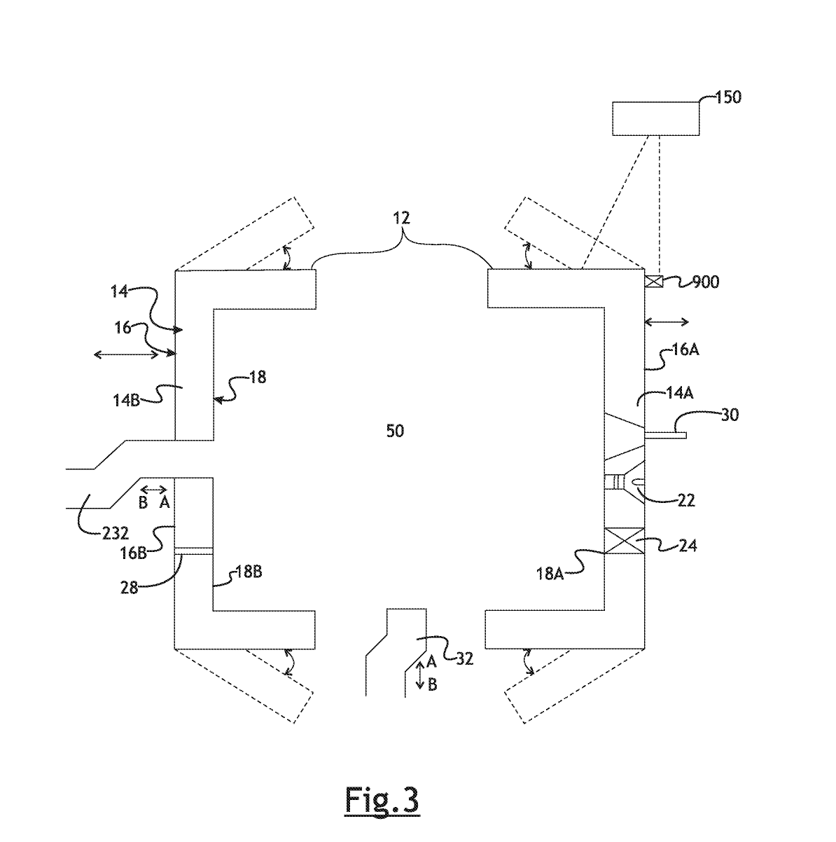

In a number of variations, in reference to FIGS. 1 and 3, the part injector 32 may reside within the first compression mold apparatus member 14A, the second compression mold apparatus member 14B, or both. In a number of variations, the part injector 32 may help form the mold cavity 50. In a number of variations, the part injector 32 may be moved manually or mechanically between first and second part injector positions A and B (and vice versa). In a number of variations, the part injector 32 may be moved mechanically, for example hydraulically by means of a drive-arm (not shown). In a number of variations, the degassing port 28 may reside within the first compression mold apparatus member 14A, the second compression mold apparatus member 14B, or both. In a number of variations, the degassing port 28 may help form the mold cavity 50. In a number of variations, the degassing port 28 may vent gas from the mold cavity 50 during operation of the mold apparatus 12. In a number of variations, the ejector pin 34 may reside within the first compression mold apparatus member 14A, the second compression mold apparatus member 14B, or both. In a number of variations, the ejector pin 34 may help form the mold cavity 50. In a number of variations, the ejector pin 34 may be moved manually or mechanically between first and second part injector positions A and B (and vice versa). In a number of variations, the ejector pin 34 may be moved mechanically, for example hydraulically by means of a drive-arm (not shown). In a number of variations, the ultrasound emitter 22 may reside within the first compression mold apparatus member 14A, the second compression mold apparatus member 14B, or both. In a number of variations, the ultrasound emitter 22 may help form the mold cavity 50. In a number of variations, the ultrasound emitter 22 may be moved manually or mechanically between first and second part injector positions A and B (and vice versa). In a number of variations, the ultrasound emitter 22 may be moved mechanically, for example hydraulically by means of a drive-arm 232. In a number of variations, the ultrasound emitter or transducer 22 may be any device capable of generating ultrasonic energy. In a number of variations, the ultrasound emitter 22 may be capable of generating ultrasonic energy in the range of about 14,000 to about 320,000 kHz. In a number of variations, the interior surfaces 18A, 18B may include a material (including, but not limited to, polymer material, metallic material, composite material or may be another type including the materials listed regarding the preform 70) that will allow the ultrasound emitter 22 to emit ultrasounds through the surface 18A, 18B and to the mold cavity 50 and to the preform 70, resin 60, or prepreg 72 during formation of the molded component 100. In a number of variations, the interior surfaces 18A, 18B may include a material (including, but not limited to, polymer material, metallic material, composite material or may be another type including the materials listed regarding the preform 70) that will allow the heating component 24 to emit heat energy through the surface 18A, 18B and to the mold cavity 50 and to the preform 70, resin 60, or prepreg 72 during formation of the molded component 100.

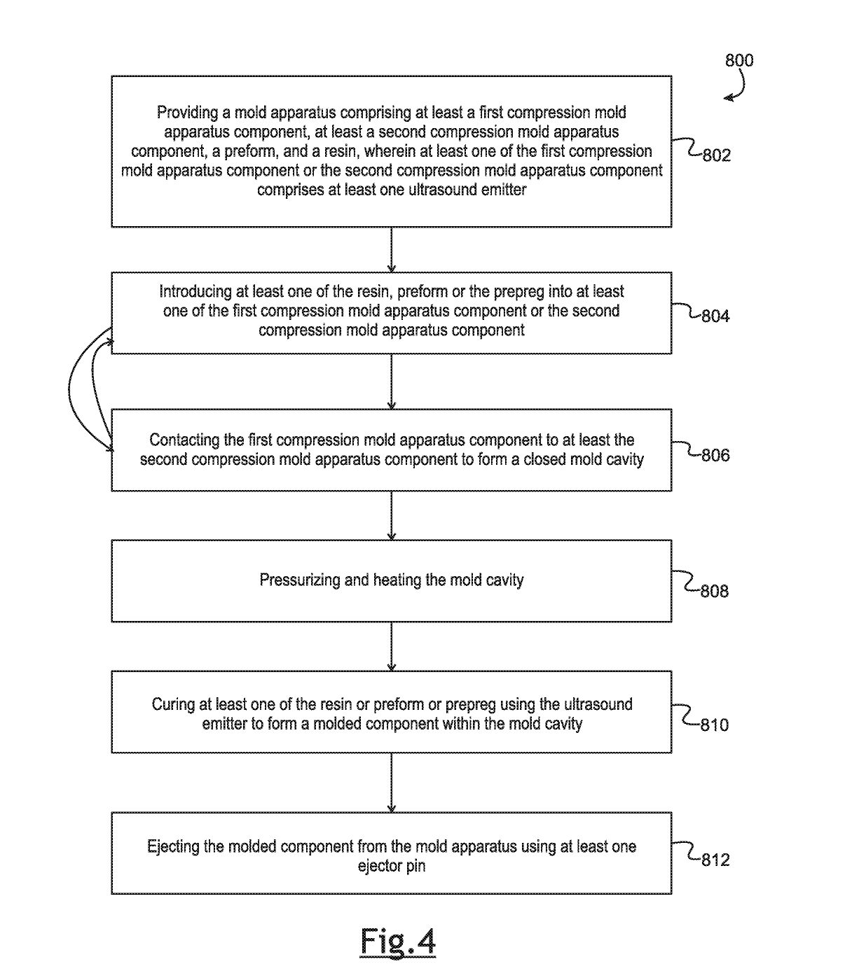

With reference to FIG. 4, in a number of variations, a method 800 is shown. In a number of variations, in step 802, the method 800 may include providing a mold apparatus 12 comprising at least a first compression mold apparatus member 14A, at least a second compression mold apparatus member 14B, a preform 70, and a resin 72, wherein at least one of the first compression mold apparatus member 14A or the second compression mold apparatus member 14B comprises at least one ultrasound emitter 22. In a number of variations, the first compression mold apparatus member 14A and/or the second compression mold apparatus member 14B may have an interior surface 18A, 18B respectively. In a number of variations, the interior surfaces 18A, 18B of the first compression mold apparatus member 14A and/or the second compression mold apparatus member 14B may be variably moved depending on the desired application shape of the finished molded component 100. In a number of variations, in step 804, the method 800 may include introducing at least one of the resin 60, preform 70 or the prepreg 72 into at least one of the first compression mold apparatus member 14A or the second compression mold apparatus member 14B. In a number of variations the introducing at least one of the preform 70 or the resin 60 or the prepreg 72 into at least one of the first compression mold apparatus member 14A or second compression mold apparatus member 14B in step 804 may further comprise orienting the preform 70 and resin 60 such that one of the preform 70 or the resin 60 is disposed on top of the other of the preform 70 or resin 60 within the first or second compression mold apparatus member 14A, 14B. In a number of variations, the resin 60, preform 70, or the prepreg 72 may be introduced separately at spaced intervals. In a number of variations, in step 806, the method 800 may include contacting the first compression mold apparatus member 14A to at least the second compression mold apparatus member 14B to form a closed mold cavity 50. In a number of variations, these steps (804, 806) may be reversed and the introduction of the preform 70, resin 60, or prepreg 72 may occur after the closed mold cavity 50 has been formed. In a number of variations, the first compression mold apparatus member 14A interior surface 18A and the second compression mold apparatus member 14AB interior surface 18B may be positioned to form a mold cavity 50 when they may be joined, combined, abutted, or form a union. In a number of variations, the mold cavity 50 may be any shape depending on the application of the molded component 100. In a number of variations, the mold cavity 50 (and the molded component 100 formed therein) may be substantially tubular having a cross sectional shape selected from circular shapes, oval shapes (e.g., elliptical shapes), polygonal shapes (e.g., triangular, rectangular—including squares, pentagonal, hexagonal, heptagonal, octagonal, etc.), irregular shapes, and combinations thereof. In a number of variations, the mold cavity 50 (and the molded protrusion formed therein) may be elongated, for example in the form of an elongated slot or channel.

In a number of variations, the first compression mold apparatus member 14A and the second compression mold apparatus member 14B may be reversibly positionable relative to each other. One the first compression mold apparatus member 14A or the second the first compression mold apparatus member 14B may be moveable, while the other may be stationary. In a number of variations, the first compression mold apparatus member 14A and the second compression mold apparatus member 14B may be reversibly positioned by known methods, for example, manually or mechanically. In a number of variations, the mold portions may be reversibly positioned by mechanical means, for example, by hydraulically driven drive-arms (not shown) along rails or tubular guides (not shown), in accordance with art-recognized methods. In a number of variations, at least one of the first compression mold apparatus member 14A or the second compression mold apparatus member 14B may be supported or suspended by a support frame 26. In a number of variations, the support frame 26 may operate to move the first compression mold apparatus member 14A and the second compression mold apparatus member 14B to form the mold cavity 50 using the mechanical means.

In a number of variations, the part injector 32 may be positioned in first part ejector position A, such that the part injector 32 may be positioned into the mold cavity 50 such that it defines at least a portion of the mold cavity 50. In a number of variations, at least one of a preform 70, resin 60 or prepreg 72 may then be introduced into mold cavity 50. In a number of variations, the preform 70, resin 60, or prepreg 72 may be introduced into the mold cavity 50 at a temperature ranging from about 100 to 350° C. and a pressure ranging from about 100 to 300 bar. In a number of variations, the preform 70, resin 60, or prepreg 72 may be heated during the introduction by the heating component 24. In a number of variations, the preform 70, resin 60, or prepreg 72 may be heated while inside the mold cavity 50 by the heating component 24.

In a number of variations, the method 800 may include, in step 808, pressurizing and heating the mold cavity 50. In a number of variations, the mold cavity 50 may be heated to a temperature ranging from about 100 to 350° C. and pressurized to a pressure ranging from about 100 to 300 bar. In a number of variations, the first compression mold apparatus member 14A may include a heating component 24A and the second mold apparatus member 14B may include a heating component 24B. In a number of variations, the heating components 24A, 24B may heat the resin 60, preform 70, or prepreg 72 at different temperatures and rates of heat during the method 800. In a number of variations, the pressurizing and heating the mold cavity 50 in step 808 may include removing or venting gas from the preform 70, resin 60, or prepreg 72. In a number of variations, the pressurizing and heating the mold cavity 50 in step 808 may include removing or venting gas from the mold cavity 50 through at least the degassing port 28. In a number of variations, the degassing port 28 may include a vacuum bag attached to the mold cavity 50. In a number of variations, a vacuum may be generated inside the mold cavity 50 during step 808 of method 800 through a vacuum pump (not shown) attached to the degassing port 28. In a number of variations, the pressurizing and heating the mold cavity 50 in step 808 of method 800 may further comprise impregnating the preform 70 with the resin 60. In a number of variations, the method 800 may include, in step 808, after introduction of at least one of the preform 70, resin 60 or prepreg 72 into the mold cavity 50, the preform 70, resin 60 or prepreg 72 may be allowed to at least partially solidify or cure. In a number of variations, the method 800 may include, in step 810, curing at least one of the resin 60 or preform 70 or prepreg 72 using the ultrasound emitter 22 to form a molded component 100 within the mold cavity 50. In a number of variations, the ultrasound emitter 22 may emit ultrasounds through the first compression mold apparatus member 14A and/or the second compression mold apparatus member 14B into the mold cavity 50 to fully cure at least one of the resin 60, prepreg 72 or preform 70. In a number of variations, the method 800 may further include, in step 812, ejecting the molded component 100 from the mold apparatus 12 using at least one ejector pin 34. In a number of variations, the part injector 32 may be retracted or moved to position B where it may be withdrawn from the mold cavity 50. In a number of variations, the part injector may move to position B along with either the first compression mold apparatus member 14A and/or the second compression mold apparatus member 14B in unison. In a number of variations, the dimensions of the mold cavity 50 may form the surfaces of the molded component 100. In a number of variations, the molded component 100 may include the surface 102 and may include at least one protrusion 104.

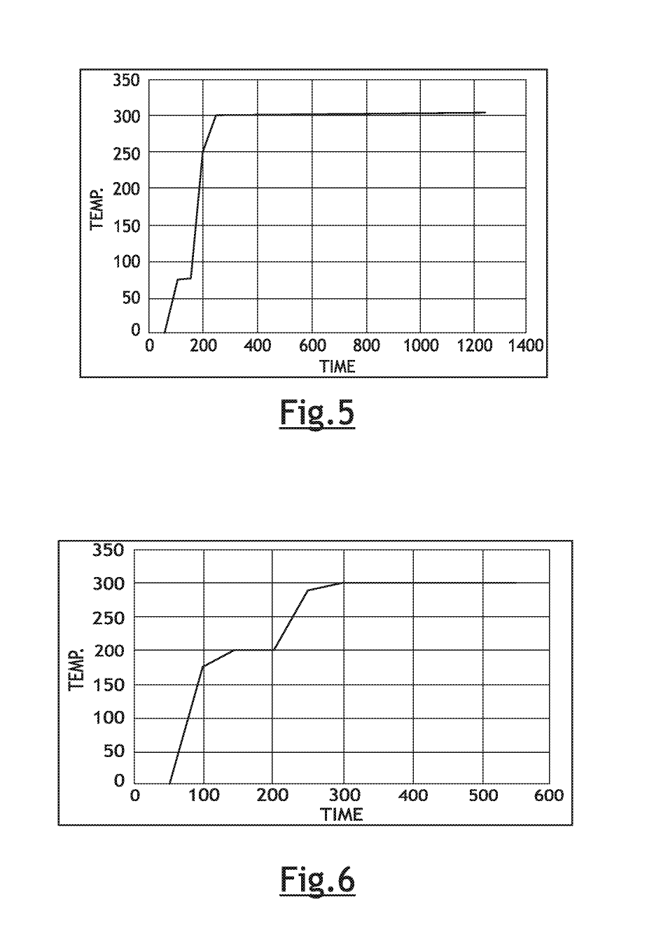

In a number of variations, the method 800 may provide a compression molding process aided with ultrasonic waves to fast cure a preform 70 containing carbon fiber and a resin 60 containing epoxy based resin. In a number of variations, this may achieve a fast cure cycle which establishes a faster method of manufacture and production capability providing for higher volume production. In a number of variations, the method 800 may allow formation of the molded component 100 in fewer than 8 minutes. In a number of variations, the molded component 100 may be a class “A” carbon fiber panel used in a vehicle. In a number of variations, the method 800 may provide a molded component 100 with a higher quality surface finish at least substantially free of air bubbles and has reduced surface defects and fiber stress. In a number of variations, as shown in FIGS. 5-6, the profiles of compression molding with an ultrasound method 800 may allow for two different temperature curves over time. In a number of variations, the compression mold method 800 provided by the compression mold apparatus 12, as shown in FIG. 6, may provide a different temperature curve over time. In a number of variations, the compression mold method 800 provided by the compression mold apparatus 12, as shown in FIG. 6, may provide a partial cure of the molded component 100 which provides a different temperature molding method 800 than a compression molding process without use of an ultrasound emitter 22 as shown in FIG. 5.

In a number of variations, an ECU 150 may be provided in the mold apparatus 12. In a number of variations the ECU 150 may receive and process input from any component within the mold apparatus 12 through at least one sensor device 900 in light of stored instructions and/or data, determine a condition through at least one calculation, and transmit output signals to various actuators, including, but not limited to, the ultrasound emitter 22, heating component 24, or actuation of the formation of the mold cavity 50 through the mechanical drive arm 232, dynamic component 52 or may another component within the mold apparatus 12. In a number of variations, the ECU 150 may monitor temperature and pressure within the mold cavity 50 through at least one sensor 900 placed in operative connection to the mold apparatus 12. In a number of variations, the ECU 150 may include, for example, an electrical circuit, an electronic circuit or chip, and/or a computer. In an illustrative computer variation, ECU 150 generally may include one or more processors, or memory storage units that may be coupled to the processor(s), and one or more interfaces electrically coupling the processor(s) to one or more other devices within the mold apparatus. The processor(s) and other powered system devices or to the at least one sensor device 900 may be supplied with electricity by a power supply. The processor(s) may execute instructions or calculations that provide at least some of the functionality for the sensor device 900 and method 800. As used herein, the term instructions may include, for example, control logic, computer software and/or firmware, programmable instructions, or other suitable instructions. The processor may include, for example, one or more microprocessors, microcontrollers, application specific integrated circuits, programmable logic devices, field programmable gate arrays, and/or any other suitable type of electronic processing device(s).

Also, in a number of variations, the ECU 150 may be configured to provide storage for data received by the at least one sensor device 900 monitoring the molding apparatus 12, for processor-executable instructions or calculations. The data, calculations, and/or instructions may be stored, for example, as look-up tables, formulas, algorithms, maps, models, and/or any other suitable format. The memory may include, for example, RAM, ROM, EPROM, and/or any other suitable type of storage article and/or device.

Further, in a number of variations, the interfaces may include, for example, analog/digital or digital/analog converters, signal conditioners, amplifiers, filters, other electronic devices or software modules, and/or any other suitable interfaces. The interfaces may conform to, for example, RS-232, parallel, small computer system interface, universal serial bus, CAN, MOST, LIN, FlexRay, and/or any other suitable protocol(s). The interfaces may include circuits, software, firmware, or any other device to assist or enable the ECU 150 in communicating with the sensors 900 or molding apparatus 12.

In a number of variations, the methods or parts thereof may be implemented in a computer program product including instructions or calculations carried on a computer readable medium for use by one or more processors to implement one or more of the method steps or instructions. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program may be executed on one processor or on multiple processors in communication with one another.

In a number of variations, the program(s) can be embodied on computer readable media, which can include one or more storage devices, articles of manufacture, or the like. Illustrative computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium also may include computer to computer connections, for example, when data may be transferred or provided over a network or another communications connection (either wired, wireless, or a combination thereof). Any combination(s) of the above examples is also included within the scope of the computer-readable media. It is therefore to be understood that the method may be at least partially performed by any electronic articles and/or devices capable of executing instructions corresponding to one or more steps of the disclosed methods.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a method comprising: providing a mold apparatus comprising at least a first compression mold apparatus member, at least a second compression mold apparatus member, a preform, and a resin, wherein at least one of the first compression mold apparatus member or the second compression mold apparatus member comprises at least one ultrasound emitter; introducing at least one of the preform or the resin into at least one of the first compression mold apparatus member or the second compression mold apparatus member; contacting the first compression mold apparatus member to at least the second compression mold apparatus member to form a closed mold cavity; pressurizing and heating the mold cavity; and curing at least one of the resin or preform using the ultrasound emitter to form a molded component within the mold cavity.

Variation 2 may include a method as set forth in Variation 1, wherein the introducing at least one of the preform or the resin into at least one of the first compression mold apparatus member or second compression mold apparatus member step further comprises orienting the preform and resin such that one of the preform or the resin is disposed on top of the other of the preform or resin within the first or second compression mold apparatus member.

Variation 3 may include a method as set forth in Variation 2 further comprising wherein the pressurizing and heating the mold cavity further comprises impregnating the preform with the resin.

Variation 4 may include a method as set forth in Variation 1-3 wherein the introducing at least one of the preform or the resin into at least one of the first compression mold apparatus member or the second compression mold apparatus member step comprises introducing a prepreg comprising the resin and the preform together within the first or second compression mold apparatus member.

Variation 5 may include a method as set forth in any of Variations 1-4 wherein the pressurizing and heating the mold cavity further comprises at least partially curing at least one of the resin or the preform.

Variation 6 may include a method as set forth in any of Variations 1-5 wherein the mold cavity contains at least one degassing port.

Variation 7 may include a method as set forth in Variation 6 wherein the pressurizing and heating the mold cavity further comprises venting gas from the mold cavity.

Variation 8 may include a method as set forth in any of Variations 1-7 wherein the preform comprises a carbon fiber.

Variation 9 may include a method as set forth in any of Variations 1-8 wherein the resin comprises an epoxy resin.

Variation 10 may include a method as set forth in any of Variations 1-9 wherein the method further includes ejecting the molded component from the mold apparatus using at least one ejector pin.

Variation 11 may include a product comprising: a mold apparatus comprising: at least one compression mold apparatus member comprising an exterior surface and an interior surface defining a thickness, and a peripheral edge; and at least one ultrasound emitter operatively attached to the compression mold apparatus member.

Variation 12 may include a product as set forth in Variation 11, wherein the compression mold apparatus member comprises at least one heating component to apply heat along at least one of the interior surface or the exterior surface of the compression mold apparatus member.

Variation 13 may include a product as set forth in any of Variations 11-12 wherein the ultrasound emitter is mounted to at least one of the exterior surface or the interior surface of the compression mold apparatus member.

Variation 14 may include a product as set forth in any of Variations 11-13 wherein the ultrasound emitter is embedded in the thickness of the compression mold apparatus member.

Variation 15 may include a product as set forth in any of Variations 11-14 wherein thickness varies along the peripheral edge of the compression mold apparatus member.

Variation 16 may include a product as set forth in any of Variations 11-15 wherein at least one of the exterior surface or interior surface defines at least a part of a mold cavity.

Variation 17 may include a product as set forth in any of Variations 11-16 further comprising a support frame supporting the compression mold apparatus member.

Variation 18 may include a product as set forth in any of Variations 11-17 wherein the compression mold apparatus member is suspended on the support frame.

Variation 19 may include a product as set forth in any of Variations 11-18 wherein the compression mold apparatus further comprises at least one degassing port.

Variation 20 may include a product as set forth in any of Variations 17-19 wherein the compression mold apparatus further comprises at least one ejector pin.

The above description of select variations within the scope of the invention is merely illustrative in nature and, thus, variations or variants thereof are not to be regarded as a departure from the spirit and scope of the invention.

What is claimed is:

1. A method comprising:
providing a mold apparatus comprising at least a first compression mold apparatus member, at least a second compression mold apparatus member, a preform, and a resin, wherein at least one of the first compression mold apparatus member or the second compression mold apparatus member comprises at least one ultrasound emitter;
introducing at least one of the preform or the resin into at least one of the first compression mold apparatus member or the second compression mold apparatus member;
contacting the first compression mold apparatus member to at least the second compression mold apparatus member to form a closed mold cavity;
pressurizing and heating the mold cavity; and
curing at least one of the resin or preform using the ultrasound emitter to form a molded component within the mold cavity.

2. A method as set forth in claim 1, wherein the introducing at least one of the preform or the resin into at least one of the first compression mold apparatus member or second compression mold apparatus member step further comprises orienting the preform and resin such that one of the preform or the resin is disposed on top of the other of the preform or resin within the first or second compression mold apparatus member.

3. A method as set forth in claim 2, wherein the pressurizing and heating the mold cavity further comprises impregnating the preform with the resin.

4. A method as set forth in claim 1, wherein the introducing at least one of the preform or the resin into at least one of the first compression mold apparatus member or the second compression mold apparatus member step comprises introducing a prepreg comprising the resin and the preform together within the first or second compression mold apparatus member.

5. A method as set forth in claim 1, wherein the pressurizing and heating the mold cavity further comprises at least partially curing at least one of the resin or the preform.

6. A method as set forth in claim 1, wherein the mold cavity contains at least one degassing port.

7. A method as set forth in claim 6, wherein the pressurizing and heating the mold cavity further comprises venting gas from the mold cavity.

8. A method as set forth in claim 1, wherein the preform comprises a carbon fiber.

9. A method as set forth in claim 1, wherein the resin comprises an epoxy resin.

10. A method as set forth in claim 1, wherein the method further includes ejecting the molded component from the mold apparatus using at least one ejector pin.

11. A product comprising:
a mold apparatus comprising: at least one compression mold apparatus member comprising an exterior surface and an interior surface defining a thickness, and a peripheral edge; and
at least one ultrasound emitter operatively attached to the compression mold apparatus member.

12. The product as set forth in claim 11, wherein the compression mold apparatus member comprises at least one heating component to apply heat along at least one of the interior surface or the exterior surface of the compression mold apparatus member.

13. The product as set forth in claim 11, wherein the ultrasound emitter is mounted to at least one of the exterior surface or the interior surface of the compression mold apparatus member.

14. The product as set forth in claim 11, wherein the ultrasound emitter is embedded in the thickness of the compression mold apparatus member.

15. The product as set forth in claim 11, wherein thickness varies along the peripheral edge of the compression mold apparatus member.

16. The product as set forth in claim 11, wherein at least one of the exterior surface or interior surface defines at least a part of a mold cavity.

17. The product as set forth in claim 11, further comprising a support frame supporting the compression mold apparatus member.

18. The product as set forth in claim 11, wherein the compression mold apparatus member is suspended on the support frame.

19. The product as set forth in claim 11, wherein the compression mold apparatus member further comprises at least one degassing port.

20. The product as set forth in claim 11, wherein the compression mold apparatus further comprises at least one ejector pin.
